(19) United States
(12) Patent Application Publication
(10) Pub. No.: US 2026/0349712 A1
(43) Pub. Date: Nov. 5, 2026

(54) AUTOMATED BATCH SIMULATION AND OUTCOME ANALYSIS FOR DECISION ARTIFACTS IN A COMPOSABLE MODULAR PLATFORM

(71) Applicant: FAIR ISAAC CORPORATION, Minneapolis, MN (US)

(72) Inventors: Baykal Hafizoglu, Atlanta, GA (US); Libin Koshy Varghese, East Brunswick, NJ (US); Horia Cristian Tipi, New York City, NY (US)

(21) Appl. No.: 19/198,592

(22) Filed: May 5, 2025

(51) Int. Cl. G06F 8/71

(52) U.S. Cl. CPC G06F 8/71

(57) ABSTRACT

A method, comprising extracting, from a decisioning artifact, a plurality of experiment parameters, wherein each of the plurality of experiment parameters is associated with a set of candidate values; generating a plurality of simulation configurations by varying the experiment parameters according to the candidate values, each of the plurality of simulation configurations corresponding to a respective version of a plurality of versions of the decisioning artifact; executing each version of the decisioning artifact with a production dataset to generate corresponding output data; evaluating one or more outcome metrics based on the output data generated for each version of the decisioning artifact; and generating a visualization configured to present a comparative analysis of the outcome metrics across the plurality of versions.

### TECHNICAL FIELD

The subject matter described herein relates to decision management technology, specifically to systems and methods for automated batch simulation and outcome-driven evaluation of decision artifacts, enabling optimization of decision logic across various applications.

### BACKGROUND

In fields such as decision management systems, fraud detection engines, and policy evaluation frameworks, the ability to evaluate and optimize decision logic configurations is critical for maintaining operational effectiveness. Traditionally, improving decision logic has required manual adjustments, repeated testing, and extensive simulation runs, creating significant delays in adapting systems to changing data patterns or operational goals. These manual efforts often lead to inefficiencies, inconsistency in evaluation results, and missed opportunities to enhance decision-making performance.

Existing approaches for evaluating decision logic tend to rely on static rule tuning or ad hoc simulation methods, which are labor-intensive and prone to human error. In these conventional systems, users must manually modify decision parameters, individually execute simulations, and separately analyze output data to assess performance. This fragmented process hampers the ability to explore a broad range of parameter variations systematically, making it difficult to identify optimal configurations that maximize system outcomes. Furthermore, as the complexity of decision systems increases, the manual trial-and-error approach becomes impractical and non-scalable.

There is a need for improved systems and methods that can automate the exploration of decision logic variations, systematically assess their impact on operational outcomes, and support scalable evaluation without requiring manual reconfiguration. Such capabilities would facilitate more efficient identification of effective decision parameter settings, enable rapid adaptation to changing operational requirements, and enhance the overall robustness and responsiveness of decision management systems.

### SUMMARY

Methods, systems, and articles of manufacture, including computer program products, are provided a method, comprise extracting, from a decisioning artifact, a plurality of experiment parameters, wherein each of the plurality of experiment parameters is associated with a set of candidate values; generating a plurality of simulation configurations by varying the experiment parameters according to the candidate values, each of the plurality of simulation configurations corresponding to a respective version of a plurality of versions of the decisioning artifact; executing each version of the decisioning artifact with a production dataset to generate corresponding output data; evaluating one or more outcome metrics based on the output data generated for each version of the decisioning artifact; and generating a visualization configured to present a comparative analysis of the outcome metrics across the plurality of versions.

In some variations, the decisioning artifact comprises a ruleset or a decision tree representing decision logic.

In some variations, evaluating the one or more outcome metrics comprises calculating a false positive rate, a false negative rate, or a net outcome metric based on the output data.

In some variations, generating the plurality of simulation configurations comprises generating a Cartesian product of the candidate values associated with the plurality of experiment parameters.

In some variations, generating the visualization comprises generating a dashboard displaying outcome metrics associated with the plurality of versions of the decisioning artifact.

In some variations, parsing the decisioning artifact comprises identifying placeholders associated with the experiment parameters.

In some variations, wherein the operations comprise identifying, from among the plurality of simulation configurations, one or more sets of experiment parameter values that optimize a selected outcome metric.

In another aspect, there is provided a computer program product including a non-transitory computer readable medium storing instructions that, when executed by at least one programmable processor, cause the at least one programmable processor to perform operations. The operations include extracting, from a decisioning artifact, a plurality of experiment parameters, wherein each of the plurality of experiment parameters is associated with a set of candidate values; generating a plurality of simulation configurations by varying the experiment parameters according to the candidate values, each of the plurality of simulation configurations corresponding to a respective version of a plurality of versions of the decisioning artifact; executing each version of the decisioning artifact with a production dataset to generate corresponding output data; evaluating one or more outcome metrics based on the output data generated for each version of the decisioning artifact; and generating a visualization configured to present a comparative analysis of the outcome metrics across the plurality of versions.

In another aspect, there is provided a system comprising: a programmable processor; and a non-transient machine-readable medium storing instructions that, when executed by the processor, cause the at least one programmable processor to perform operations. The operations include extracting, from a decisioning artifact, a plurality of experiment parameters, wherein each of the plurality of experiment parameters is associated with a set of candidate values; generating a plurality of simulation configurations by varying the experiment parameters according to the candidate values, each of the plurality of simulation configurations corresponding to a respective version of a plurality of versions of the decisioning artifact; executing each version of the decisioning artifact with a production dataset to generate corresponding output data; evaluating one or more outcome metrics based on the output data generated for each version of the decisioning artifact; and generating a visualization configured to present a comparative analysis of the outcome metrics across the plurality of versions.

Implementations of the current subject matter can include, but are not limited to, methods consistent with the descriptions provided herein as well as articles that include a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates an example simulation evaluation workflow according to certain embodiments described herein.

FIG. 2 illustrates an example simulation evaluation workflow in accordance with some embodiments of the approach described herein.

FIG. 3 illustrates a flowchart of an example process 300 for automated batch simulation and evaluation of decision logic, in accordance with one or more embodiments of the approach described herein.

FIG. 4A illustrates an example user interface 400 for presenting simulation evaluation results, in accordance with one or more embodiments of the approach described herein.

FIG. 4B illustrates an example user interface for presenting simulation evaluation results based on two varying experiment parameters, in accordance with some embodiments of the approach described herein.

FIG. 5 depicts a block diagram illustrating a computing system consistent with implementations of the current subject matter.

When practical, like labels are used to refer to same or similar items in the drawings.

### DETAILED DESCRIPTION

The details of one or more variations of the subject matter described herein are set forth in the accompanying drawings.

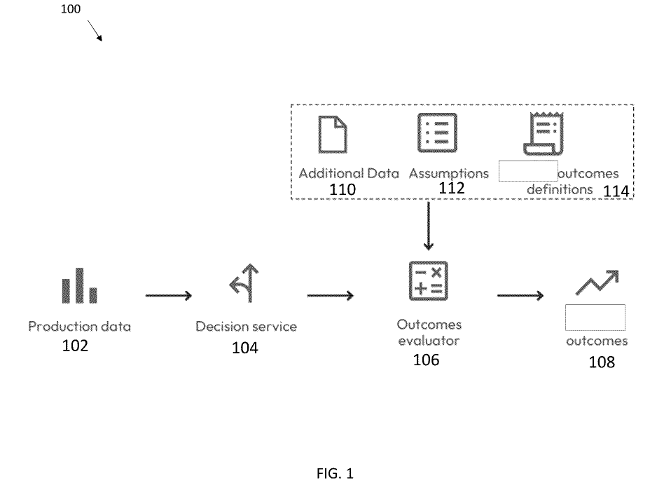

FIG. 1 illustrates an example simulation evaluation workflow according to certain embodiments described herein. The illustrated workflow includes multiple interconnected modules and data components designed to facilitate systematic evaluation and optimization of decision logic through automated simulations. As shown in FIG. 1, the workflow begins with production data 102, which represents historical or operational data relevant to the decision scenarios being evaluated. This production data 102 may consist of transactional records, user behavior logs, application-specific events, or other types of structured data collected from real-world operations. Production data 102 is provided as input to a decision service 104. The decision service 104 embodies one or more decisioning artifacts, such as rulesets, decision trees, or other forms of decision logic that process the incoming production data 102. In operation, the decision service 104 executes the decision logic contained within these artifacts to produce decision outcomes for each data record or event within the production data 102. Upon processing the production data 102, the decision service 104 outputs results that reflect the decisions or actions recommended or determined by the executed decisioning artifacts. These outputs are subsequently delivered to an outcome evaluator 106, which is configured to quantitatively assess and evaluate the performance of the decision service 104. The outcomes evaluator 106 accomplishes this by calculating specific outcome metrics that measure the effectiveness, accuracy, or overall performance of the decisions produced by the decision service 104. In addition to the direct outputs received from the decision service 104, the outcomes evaluator 106 utilizes supplementary information sources to comprehensively compute these outcome metrics. Specifically, additional data 110 is provided to the outcome evaluator 106, representing external datasets or ancillary information not directly used by the decision service 104 but essential for certain outcome calculations.

The additional data 110 may encompass contextual information, external reference data, or secondary operational statistics required to accurately interpret or enhance the evaluation of the primary outputs from the decision service 104. The outcomes evaluator 106 also incorporates assumptions 112 into its computations. These assumptions 112 include predefined constants, thresholds, policy guidelines, or other forms of criteria that influence how outcomes are calculated.

The assumptions 112 serve as configurable parameters or fixed conditions that provide consistency and interpretative context for evaluating the outputs from the decision service 104. By adjusting these assumptions 112, different evaluation scenarios and conditions can be simulated to understand various potential implications of the decision logic. Additionally, the outcomes evaluator 106 references outcome definitions 114, which specify mathematical formulas, logical expressions, or computational instructions used explicitly to calculate the outcome metrics.

Outcome definitions 114 define precisely how raw data outputs from the decision service 104 and the additional data 110 should be combined, aggregated, or otherwise processed, based on the assumptions 112, to yield meaningful quantitative outcome results. The outcomes evaluator 106 then computes the final outcome metrics by systematically applying the outcome definitions 114 to the data received from the decision service 104, in combination with the additional data 110 and guided by the assumptions 112. The resultant outcome metrics, collectively represented as outcomes 108, provide a quantifiable measure of the decision logic's performance, effectiveness, or efficiency.

These outcomes 108 can subsequently be utilized for detailed analysis, further comparison, or visualization, enabling users to clearly understand the implications of different decision logic variations and facilitate informed optimization. Through this integrated workflow, comprising production data 102, decision service 104, outcomes evaluator 106, additional data 110, assumptions 112, outcome definitions 114, and resulting outcomes 108, the described approach supports efficient, scalable, and repeatable evaluation of decision logic. This workflow reduces manual efforts traditionally involved in simulating multiple configurations, enhances evaluation accuracy through structured assumptions and definitions, and significantly accelerates the optimization of decision-making processes.

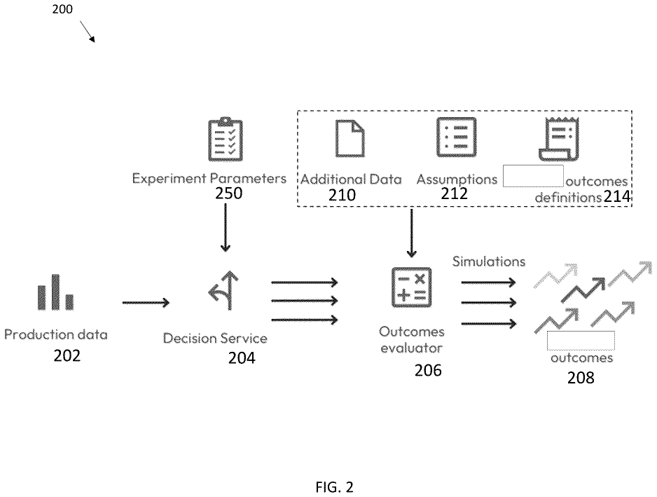

FIG. 2 illustrates an example simulation evaluation workflow in accordance with some embodiments of the approach described herein. The workflow depicted in FIG. 2 expands upon the evaluation structure shown previously by incorporating experiment parameters 250, which enable automated adjustment of the decision service 204. In some embodiments, these experiment parameters 250 may comprise adjustable variables, thresholds, weights, or constraints applied within the decision logic contained by the decision service 204. Each experiment parameter 250 may be associated with multiple candidate values, which allow for the generation of different versions of decision logic, thus enabling multiple simulations. Production data 202, which may include operational records or historical data such as transactions or event logs, is provided as input to the decision service 204. For example, the decision service 204 may utilize each distinct set of experiment parameters 250 to independently process the production data 202, resulting in multiple simulation outcomes. In this manner, several distinct simulations may be performed automatically, without requiring manual adjustment of the underlying decision logic between simulations.

Outcomes generated by the decision service 204 for each simulation are subsequently delivered to an outcomes evaluator 206. The outcomes evaluator 206 calculates specific outcome metrics based on inputs from the decision service 204 and, in some embodiments, further utilizes additional data 210, assumptions 212, and outcome definitions 214. Additional data 210 may include contextual or supplementary data sources not directly involved in the initial decision processing.

Assumptions 212 may encompass predefined thresholds, constants, or conditions influencing outcome evaluation, while outcome definitions 214 explicitly detail mathematical expressions or computational methods for evaluating and quantifying outcomes. Through the described workflow, multiple sets of outcome metrics 208 corresponding to each simulation configuration are produced. These outcome metrics 208 provide quantitative assessments of each simulation's performance, enabling users to systematically compare and identify parameter configurations that may yield enhanced performance in practical scenarios.

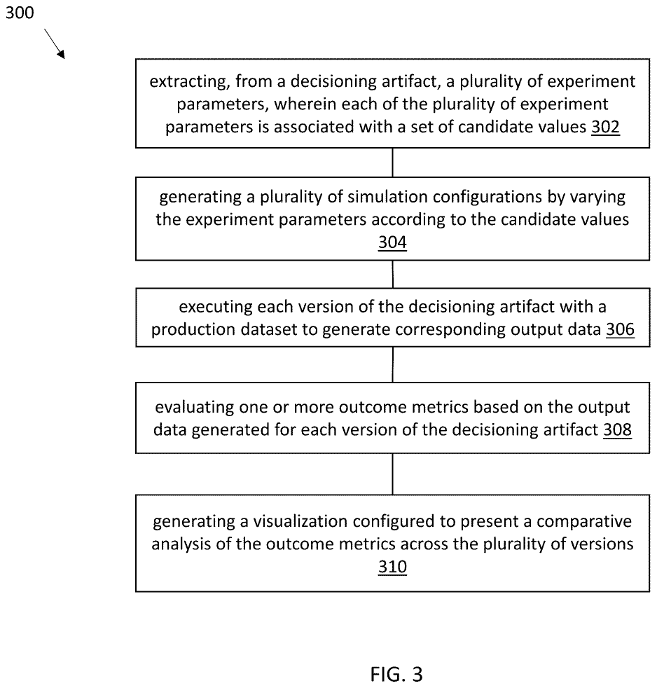

FIG. 3 illustrates a flowchart of an example process 300 for automated batch simulation and evaluation of decision logic, in accordance with one or more embodiments of the approach described herein. As shown in FIG. 3, the process 300 may begin with operation 302, wherein the system may extract, from a decisioning artifact, a plurality of experiment parameters. For example, a decisioning artifact may refer to a structured representation of decision logic, such as a ruleset or decision tree, containing configurable parameters. Each of these experiment parameters may be associated with a set of candidate values that define potential adjustments or variations of the decision logic.

Next, in operation 304, the system may generate a plurality of simulation configurations by systematically varying the extracted experiment parameters according to their associated candidate values. For example, this operation may involve generating a Cartesian product of candidate values, resulting in numerous distinct versions of the original decisioning artifact, each embodying a unique configuration of parameters. In some embodiments, generating the plurality of simulation configurations may specifically comprise combining candidate values associated with multiple parameters to cover comprehensive possible parameter variations.

The process 300 then advances to operation 306, where the system may execute each generated version of the decisioning artifact using a production dataset. The production dataset, in some embodiments, comprises historical operational data, such as transaction records or event logs, which are relevant to evaluating the practical impact of different decision logic versions. For example, a decisioning artifact may include one or more placeholders representing experiment parameters. A placeholder refers to a designated location or token within the decisioning artifact that can be replaced with different candidate values during simulation configuration generation. Executing each artifact version involves parsing the decisioning artifact to identify locations of experiment parameters and collectively replacing values at these locations based on each specific simulation configuration.

In some embodiments, before execution, the system may validate the modified decisioning artifact to ensure structural consistency and correctness. In operation 308, the system may evaluate one or more outcome metrics based on output data generated from executing each version of the decisioning artifact. For example, evaluating the outcome metrics may involve calculating metrics such as false positive rates, false negative rates, approval ratios, or other application-specific performance indicators. In some embodiments, the evaluation may use predefined mathematical expressions and may incorporate additional data sources, assumptions, and outcome definitions to accurately and comprehensively assess the decision logic performance.

The process 300 subsequently proceeds to operation 310, wherein the system generates a visualization configured to present a comparative analysis of the evaluated outcome metrics across the plurality of decision artifact versions. In some embodiments, generating the visualization may involve creating interactive dashboards that include sortable tables, charts, or other graphical representations, thereby allowing users to intuitively explore, filter, and compare performance across multiple simulated configurations. In some embodiments, as a more specific modification, the decisioning artifact used in operation 302 may specifically comprise decision logic implemented as rulesets or decision trees, which allow structured and hierarchical definitions of decision-making processes. Further, in some embodiments, the production dataset described in operation 306 may specifically include historical transaction records collected from prior operational activities to realistically simulate practical conditions.

Additionally, in some embodiments, the evaluation described in operation 308 may specifically comprise computing outcome metrics such as false positive rate, false negative rate, or net outcome metrics. For example, outcome metrics may be computed using specific assumptions or thresholds that reflect desired operational targets or constraints. In some examples, outcome metrics may further include a net outcome metric, which refers to a composite evaluation that balances multiple factors such as gains and losses, approvals and denials, or benefits and costs, to provide a consolidated performance measure.

Furthermore, in some embodiments, generating the visualization as described in operation 310 may include creating summary charts or interactive dashboards, facilitating user interaction for detailed comparative analysis and aiding informed decision-making regarding optimal decision logic configurations. The described approach, therefore, provides automated and systematic mechanisms for efficiently exploring, evaluating, and visualizing numerous variations of decision logic, significantly reducing manual efforts and supporting rapid optimization of decision system performance.

In some cases, the system may further identify one or more sets of experiment parameter values that optimize a selected outcome metric. For example, following the evaluation of outcome metrics across multiple simulation configurations, the system may rank the simulation configurations according to the values of one or more selected outcome metrics. A ranking procedure may involve sorting the simulation configurations based on performance criteria, such as minimizing a false positive rate, maximizing a true positive rate, reducing operational costs, or achieving an optimal balance between competing metrics. In some examples, optimization may be defined based on a weighted combination of multiple outcome metrics to reflect complex decision objectives.

Once the configurations are ranked, the system may select one or more top-performing configurations that satisfy predefined optimization thresholds or selection criteria. These criteria may include absolute metric thresholds (e.g., a stockout rate below a specific percentage) or relative improvements over baseline configurations. In some embodiments, the system may automatically surface the highest-performing experiment parameter sets to a user interface, enabling users to further inspect or refine the selected configurations. In other cases, the system may suggest alternative parameter sets that are near-optimal, allowing for flexibility in balancing performance trade-offs under different operational constraints. Through this optimization capability, users may efficiently identify parameter settings that are likely to enhance system performance without requiring manual inspection of every simulation result.

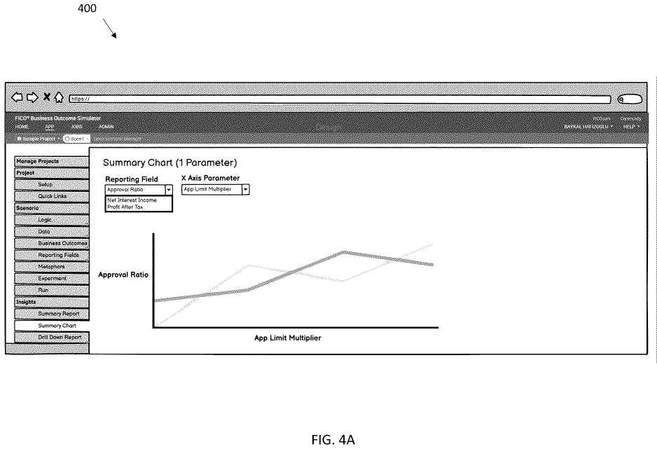

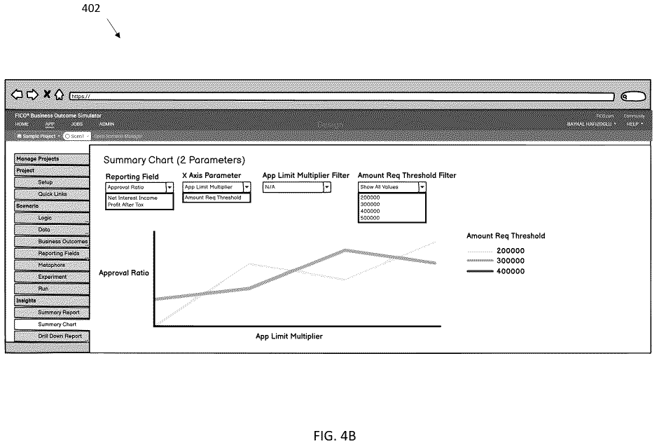

FIG. 4A illustrates an example user interface 400 for presenting simulation evaluation results, in accordance with one or more embodiments of the approach described herein. As shown in FIG. 4A, the user interface 400 includes various regions and selectable controls configured to facilitate interaction with simulation outcome data generated based on different configurations of decisioning artifacts.

In some embodiments, the user interface 400 may display a navigation panel on a left-hand side. The navigation panel may include sections such as “Manage Projects,” “Project,” “Scenario,” and “Insights.” Under the “Project” section, a user may be provided with selectable controls for setup and quick links. Under the “Scenario” section, controls for accessing logic, data, outcome definitions, reporting fields, metaphors, experiments, and run operations may be displayed. Under the “Insights” section, users may be presented with options for accessing a summary report, a summary chart, and a drill-down report. The navigation panel may enable users to conveniently manage workflows associated with different simulation projects and scenarios.

In some embodiments, the main display area of the user interface 400 presents a summary chart visualization. The summary chart is configured to display a comparative graphical representation of outcome metrics corresponding to different simulation configurations. As illustrated, the summary chart may be titled “Summary Chart (1 Parameter),” indicating that the comparative analysis is based on a single experiment parameter.

In the illustrated example, the user interface 400 includes a “Reporting Field” dropdown menu, which enables a user to select a particular outcome metric to be visualized. For example, the selectable reporting fields may include “Approval Ratio,” “Net Interest Income,” and “Profit After Tax.” Each selectable field may correspond to a specific outcome metric evaluated based on the execution of decision artifact versions. In some embodiments, selecting a reporting field dynamically updates the chart to reflect the outcome metric values associated with the different parameter settings.

Additionally, the user interface 400 includes an “X Axis Parameter” dropdown menu, allowing a user to select an experiment parameter for the x-axis of the summary chart. In the illustrated example, “App Limit Multiplier” is shown as the selected x-axis parameter. In some embodiments, an experiment parameter refers to a tunable configuration element extracted from a decisioning artifact and associated with a plurality of candidate values. The values of the selected experiment parameter are plotted along the x-axis, and the corresponding outcome metric values are plotted along the y-axis.

The summary chart may depict one or more lines representing different simulation runs. Each line may correspond to a distinct configuration or experimental variation of the decisioning artifact. For example, the different lines may reflect different combinations of other parameters held constant while varying the selected x-axis parameter. In some embodiments, the system may dynamically generate such comparative visualizations based on simulation output data and facilitate user exploration of performance trends across parameter variations.

The user interface 400 further includes an address bar at the top, which may display the URL or location associated with the web-based simulation evaluation platform. Navigation controls such as home, back, forward, and refresh buttons may also be included in the top navigation bar, enabling standard web browsing interactions.

In some embodiments, the summary chart visualization may be dynamically interactive. For example, a user may hover over or click on data points to reveal detailed numerical values associated with specific simulation configurations. Additionally, users may filter or sort the displayed data through configurable options, allowing for customized comparative analysis.

Through the integrated controls and dynamic visualizations presented in the user interface 400, users may efficiently identify optimal parameter settings for decision artifacts based on the visualized outcome metrics. In some embodiments, the user interface 400 supports enhanced decision logic optimization by providing systematic and intuitive access to simulation evaluation results across various parameter configurations.

In some embodiments, additional features such as exporting the summary chart, toggling between different types of charts (e.g., line charts, bar charts), and drilling down into specific simulation runs for more granular analysis may be supported. These features may further facilitate a flexible and scalable evaluation framework suitable for diverse application scenarios.

The approach described herein, as exemplified in FIG. 4A, thus provides an efficient and user-friendly mechanism for analyzing, comparing, and optimizing decision logic configurations based on automated simulation outputs and systematically visualized evaluation results.

FIG. 4B illustrates an example user interface for presenting simulation evaluation results based on two varying experiment parameters, in accordance with some embodiments of the approach described herein. As shown in FIG. 4B, the user interface provides enhanced capabilities compared to single-parameter analysis by enabling users to simultaneously explore the effects of two distinct experiment parameters on selected outcome metrics.

The user interface 402 includes a navigation panel located on the left-hand side, which presents project management options, scenario configuration controls, and insights access functions. Under the “Insights” section, users may select “Summary Chart” to access the display shown in FIG. 4B.

Within the main display area, the title “Summary Chart (2 Parameters)” is shown, indicating that the analysis involves two experiment parameters. The user interface includes a “Reporting Field” dropdown menu, enabling selection of an outcome metric such as “Approval Ratio,” “Net Interest Income,” or “Profit After Tax.” The “Reporting Field” selection determines the performance metric that will be visualized on the chart.

In some embodiments, the user interface further includes an “X Axis Parameter” selection menu, allowing users to choose the primary parameter plotted along the x-axis. Available options may include “App Limit Multiplier” and “Amount Req Threshold.” Additionally, filtering options associated with each selected parameter are presented through the “App Limit Multiplier Filter” and the “Amount Req Threshold Filter.” These filters may allow users to limit the displayed data to specific subsets of parameter values, enhancing the focus and relevance of the comparative analysis.

The summary chart displays a plurality of lines, each representing the simulation results corresponding to a different value of the second experiment parameter. For example, different lines may correspond to different “Amount Req Threshold” settings (e.g., 200,000; 300,000; 400,000). Each line illustrates how the selected outcome metric varies as a function of the primary x-axis parameter, enabling users to simultaneously evaluate the impacts of both experiment parameters on system performance.

In some embodiments, the chart may further include a legend to assist users in interpreting which line corresponds to which filter setting or value of the secondary parameter. The chart may be dynamically updated based on user selections from the reporting field menu, parameter selections, and active filter conditions.

Through the expanded functionality illustrated in FIG. 4B, users may perform multidimensional simulation result analysis, gaining deeper insights into interactions between different decision parameters. In some embodiments, users may interactively adjust filter conditions, swap primary and secondary parameters, and dynamically refresh the visualization, facilitating a more flexible and comprehensive evaluation process. The approach described herein, as exemplified in FIG. 4B, thus supports more sophisticated exploration and comparison of decision logic variations through dual-parameter analysis and interactive visualization mechanisms.

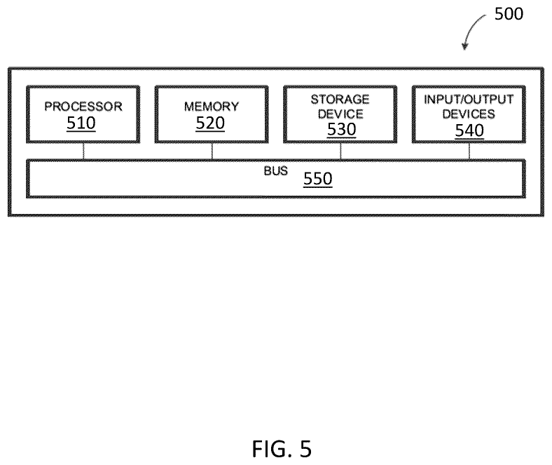

FIG. 5 depicts a block diagram illustrating a computing system 500 consistent with implementations of the current subject matter. As shown in FIG. 5, the computing system 500 can include a processor 510, a memory 520, a storage device 530, and input/output devices 540. The processor 510, the memory 520, the storage device 530, and the input/output devices 540 can be interconnected via a system bus 550. The computing system 500 may additionally or alternatively include a graphic processing unit (GPU), such as for image processing, and/or an associated memory for the GPU. The GPU and/or the associated memory for the GPU may be interconnected via the system bus 550 with the processor 510, the memory 520, the storage device 530, and the input/output devices 540. The memory associated with the GPU may store one or more images described herein, and the GPU may process one or more of the images described herein. The GPU may be coupled to and/or form a part of the processor 510. The processor 510 is capable of processing instructions for execution within the computing system 500. In some implementations of the current subject matter, the processor 510 can be a single-threaded processor. Alternately, the processor 510 can be a multi-threaded processor. The processor 510 is capable of processing instructions stored in the memory 520 and/or on the storage device 530 to display graphical information for a user interface provided via the input/output device 540.

The memory 520 is a computer-readable medium, such as volatile or non-volatile memory, that stores information within the computing system 500. The memory 520 can store data structures representing configuration object databases, for example. The storage device 530 is capable of providing persistent storage for the computing system 500. The storage device 530 can be a floppy disk device, a hard disk device, an optical disk device, or a tape device, or other suitable persistent storage means. The input/output device 540 provides input/output operations for the computing system 500. In some implementations of the current subject matter, the input/output device 540 includes a keyboard and/or pointing device. In various implementations, the input/output device 540 includes a display unit for displaying graphical user interfaces.

According to some implementations of the current subject matter, the input/output device 540 can provide input/output operations for a network device. For example, the input/output device 540 can include Ethernet ports or other networking ports to communicate with one or more wired and/or wireless networks (e.g., a local area network (LAN), a wide area network (WAN), the Internet).

In some implementations of the current subject matter, the computing system 500 can be used to execute various interactive computer software applications that can be used for organization, analysis and/or storage of data in various (e.g., tabular) format (e.g., Microsoft Excel®, and/or any other type of software). Alternatively, the computing system 1000 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 540. The user interface can be generated and presented to a user by the computing system 500 (e.g., on a computer screen monitor, etc.).

One or more aspects or features of the subject matter described herein can be realized in digital electronic circuitry, integrated circuitry, specially designed framework specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software frameworks, frameworks, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

### Use Case

In a supply chain optimization context, the approach described herein may be applied to systematically evaluate different configurations of inventory and replenishment policies to improve operational efficiency and reduce costs.

Consider an organization that manages a network of regional distribution centers responsible for fulfilling retail store demands. The supply chain management team seeks to optimize several parameters that directly influence inventory holding costs, stockout rates, and overall service levels. Key decision parameters include the safety stock levels at each distribution center, the reorder thresholds that trigger replenishment orders, and the transportation modes selected for shipments from suppliers.

Using the approach described herein, the system first extracts a plurality of experiment parameters from the supply chain decisioning logic. These experiment parameters may include safety stock multipliers (e.g., 1.2×, 1.5×, 2.0× baseline forecast), reorder thresholds (e.g., 10 days, 15 days, 20 days of forecasted demand), and transportation modes (e.g., standard shipping, expedited air freight). Each parameter is associated with a set of candidate values representing alternative settings under consideration.

The system generates a plurality of simulation configurations by varying the extracted experiment parameters according to their respective candidate values. For example, combining three different safety stock levels, three reorder thresholds, and two transportation modes would yield eighteen unique configurations. Each configuration represents a potential supply chain policy that could be implemented across the network.

The system then executes each version of the decisioning artifact by simulating the historical order, shipment, and inventory data against the specified configuration. For each simulation, the system processes production data consisting of prior periods'store order patterns, supplier delivery lead times, and fulfillment performance metrics. Each simulated execution generates output data capturing inventory positions over time, backorder instances, shipment delays, and associated operational costs.

Following execution, the system evaluates a set of outcome metrics for each configuration. The evaluated metrics may include inventory holding cost, stockout rate, transportation cost, average fulfillment lead time, and overall service level achievement. These outcome metrics are derived based on standardized evaluation logic, applying mathematical formulas to simulation output data, potentially incorporating external data sources such as supplier reliability ratings or seasonal demand adjustments.

The results are presented through a comparative visualization that allows the supply chain management team to intuitively assess the trade-offs between different configurations. For instance, configurations using higher safety stock multipliers may show reduced stockout rates but increased holding costs, while configurations emphasizing expedited shipping modes may demonstrate improved service levels at the expense of transportation expenses.

Through this automated simulation and evaluation process, the organization can systematically identify supply chain strategies that achieve an optimal balance among competing objectives, such as minimizing costs while maintaining high service levels. Decision-makers may quickly narrow down to a subset of configurations that meet predefined performance criteria and explore adjustments to parameter values to further refine the supply chain strategy.

This use case highlights how the approach described herein enables scalable, data-driven evaluation of complex supply chain decisions, significantly reducing reliance on manual what-if analysis, accelerating decision cycles, and improving the robustness of supply chain optimization initiatives.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A computer-implemented method, comprising:
extracting, from a decisioning artifact, a plurality of experiment parameters, wherein each of the plurality of experiment parameters is associated with a set of candidate values;
generating a plurality of simulation configurations by varying the experiment parameters according to the candidate values, each of the plurality of simulation configurations corresponding to a respective version of a plurality of versions of the decisioning artifact;
executing each version of the decisioning artifact with a production dataset to generate corresponding output data;
evaluating one or more outcome metrics based on the output data generated for each version of the decisioning artifact; and
generating a visualization configured to present a comparative analysis of the outcome metrics across the plurality of versions,
wherein executing each version of the decisioning artifact comprises parsing the decisioning artifact to locate the plurality of experiment parameters, and collectively replacing a combination of values associated with the plurality of experiment parameters based on a corresponding simulation configuration.

2. The method of claim 1, wherein the decisioning artifact comprises a ruleset or a decision tree representing decision logic.

3. The method of claim 1, wherein evaluating the one or more outcome metrics comprises calculating a false positive rate, a false negative rate, or a net outcome metric based on the output data.

4. The method of claim 1, wherein generating the plurality of simulation configurations comprises generating a Cartesian product of the candidate values associated with the plurality of experiment parameters.

5. The method of claim 1, wherein generating the visualization comprises generating a dashboard displaying outcome metrics associated with the plurality of versions of the decisioning artifact.

6. The method of claim 1, wherein parsing the decisioning artifact comprises identifying placeholders associated with the experiment parameters.

7. The method of claim 1, further comprising:
identifying, from among the plurality of simulation configurations, one or more sets of experiment parameter values that optimize a selected outcome metric.

8. A system comprising:
at least one programmable processor; and
a non-transient machine-readable medium storing instructions that, when executed by the processor, cause the at least one programmable processor to perform operations comprising:
extracting, from a decisioning artifact, a plurality of experiment parameters, wherein each of the plurality of experiment parameters is associated with a set of candidate values;
generating a plurality of simulation configurations by varying the experiment parameters according to the candidate values, each of the plurality of simulation configurations corresponding to a respective version of a plurality of versions of the decisioning artifact;
executing each version of the decisioning artifact with a production dataset to generate corresponding output data;
evaluating one or more outcome metrics based on the output data generated for each version of the decisioning artifact; and
generating a visualization configured to present a comparative analysis of the outcome metrics across the plurality of versions,
wherein executing each version of the decisioning artifact comprises parsing the decisioning artifact to locate the plurality of experiment parameters, and collectively replacing a combination of values associated with the plurality of experiment parameters based on a corresponding simulation configuration.

9. The system of claim 8, wherein the decisioning artifact comprises a ruleset or a decision tree representing decision logic.

10. The system of claim 8, wherein evaluating the one or more outcome metrics comprises calculating a false positive rate, a false negative rate, or a net outcome metric based on the output data.

11. The system of claim 8, wherein generating the plurality of simulation configurations comprises generating a Cartesian product of the candidate values associated with the plurality of experiment parameters.

12. The system of claim 8, wherein generating the visualization comprises generating a dashboard displaying outcome metrics associated with the plurality of versions of the decisioning artifact.

13. The system of claim 8, wherein parsing the decisioning artifact comprises identifying placeholders associated with the experiment parameters.

14. The system of claim 8, wherein the operations further comprise identifying, from among the plurality of simulation configurations, one or more sets of experiment parameter values that optimize a selected outcome metric.

15. A computer program product comprising a non-transient machine-readable medium storing instructions that, when executed by at least one programmable processor, cause the at least one programmable processor to perform operations comprising:
extracting, from a decisioning artifact, a plurality of experiment parameters, wherein each of the plurality of experiment parameters is associated with a set of candidate values;
generating a plurality of simulation configurations by varying the experiment parameters according to the candidate values, each of the plurality of simulation configurations corresponding to a respective version of a plurality of versions of the decisioning artifact;
executing each version of the decisioning artifact with a production dataset to generate corresponding output data;
evaluating one or more outcome metrics based on the output data generated for each version of the decisioning artifact; and
generating a visualization configured to present a comparative analysis of the outcome metrics across the plurality of versions,
wherein executing each version of the decisioning artifact comprises parsing the decisioning artifact to locate the plurality of experiment parameters, and collectively replacing a combination of values associated with the plurality of experiment parameters based on a corresponding simulation configuration.

16. The computer program product of claim 15, wherein the decisioning artifact comprises a ruleset or a decision tree representing decision logic.

17. The computer program product of claim 15, wherein evaluating the one or more outcome metrics comprises calculating a false positive rate, a false negative rate, or a net outcome metric based on the output data.

18. The computer program product of claim 15, wherein generating the plurality of simulation configurations comprises generating a Cartesian product of the candidate values associated with the plurality of experiment parameters.

19. The computer program product of claim 15, wherein generating the visualization comprises generating a dashboard displaying outcome metrics associated with the plurality of versions of the decisioning artifact.

20. The computer program product of claim 15, wherein parsing the decisioning artifact comprises identifying placeholders associated with the experiment parameters.
